(19) United States
(12) Patent Application Publication
(10) Pub. No.: US 2022/0292469 A1
(43) Pub. Date: Sep. 15, 2022

(54) ELECTRONIC PAYMENT AGENCY METHOD AND SYSTEM USING VIRTUAL CURRENCY WITH LIMIT GRANTED BASED ON CRYPTOCURRENCY PROVIDED AS COLLATERAL

(71) Applicants: SUNGJUN AN, Seoul (KR); DAEYOUNG AN, Busan (KR); MIRAE FINTECH Co., Ltd., Seoul (KR)

(72) Inventors: SUNGJUN AN, Seoul (KR); DAEYOUNG AN, Busan (KR)

(21) Appl. No.: 17/692,173

(22) Filed: Mar. 11, 2022

(30) Foreign Application Priority Data
Mar. 11, 2021 (KR) 10-2021-0032139
Feb. 28, 2022 (KR) 10-2022-0026149

(51) Int. Cl. G06Q 20/06; G06Q 20/40

(52) U.S. Cl. CPC G06Q 20/065; G06Q 20/4037; G06Q 20/405; G06Q 40/06

(57) ABSTRACT

Provided is a payment agency server which grants a virtual currency limit on the basis of a crypto-currency collateral providing signal received from the user terminal or the exchange market server, transmits a virtual currency information providing signal to the user terminal or the exchange market server, and processes payment when a virtual currency payment request signal is received from the user terminal or the payment request terminal.

### CROSS-REFERENCE TO RELATED APPLICATIONS

This application claims priority to (i) Korean Application No. 10-2021-0032139 filed on Mar. 11, 2021 and (ii) Korean Application No. 10-2022-0026149 filed on Feb. 28, 2022, the entire contents of which are herein incorporated by reference in their entirety.

### TECHNICAL FIELD

The present invention relates to e-commerce or electronic remittance, and more particularly, to an electronic payment in e-commerce or electronic remittance using a virtual currency with a limit granted based on a blockchain-based cryptocurrency provided as collateral.

### BACKGROUND OF THE INVENTION

In real economy, fiat money such as cash has been used as a payment means in the past as a return for providing goods and services. However, in the present days, with the development of e-commerce and remittance technologies, electronic money belonging to the Central Bank Digital Currency (CBDC), which electronically implements the function of the fiat money, is used as an electronic payment means, and not everyone is allowed to issue or distribute the fiat money and the electronic money (hereinafter, referred to as fiat currency) in accordance with relevant laws.

As the management and supervision authority for the issuance and distribution of currency is centralized in this way in the past, it needs to construct a system for monitoring each other through decentralization, and techniques for issuing and distributing currency of a new concept, such as digital-based virtual currency or cryptocurrency, draw much attention recently.

Virtual currency is a digital asset or a virtual asset, which is a currency or a token that can be used in a virtual payment or environment in place of fiat currency.

Cryptocurrency is a digital or virtual asset belonging to virtual currency or having the same meaning as the virtual currency, and describing a brief technical background, blocks are formed as the ownership or transaction status of cryptocurrency is continuously recorded in blocks acting as a ledger, and as transaction records are left based on blockchains connecting these blocks in the form of a chain and distributed ledgers are constructed by nodes, it is implemented as a technique for preventing double spending in a method of mutual verification through decentralization, and a representative cryptocurrency is Bitcoin.

However, in the case of a cryptocurrency such as Bitcoin, as the number of mining participants who record a transaction book and receive compensations, the difficulty in mining increases, so that it becomes difficult for general users to acquire currency, and considerable computing power is also required for transaction records and proof. In addition, since the processing speed is also low due to the nature of the distributed ledgers and the value rises as the scarcity increases, the tendency to possess the cryptocurrency as an asset increase, and there is a big disadvantage in that it is not circulated as a currency of real economy.

As various types of cryptocurrencies with various characteristics, based on or applying blockchain or smart contract, have been announced recently to solve this problem, it is attempted in various fields to distribute the cryptocurrencies as a currency in connection with the real economy. In the case of e-commerce payment among them, a method of making a direct payment or remittance in a cryptocurrency possessed bye a user, immediately exchanging cryptocurrency with fiat currency according to a cryptocurrency market price at the time point of using e-commerce and using the fiat currency for payment, or exchanging the cryptocurrency with a cryptocurrency issued by a payment agency itself and using the fiat currency for payment is attempted. However, the problem of making a payment in a way of changing the ownership itself of the cryptocurrency like this is that it is inconvenient to purchase or exchange cryptocurrency in advance through an exchange market or the like for each payment to use the e-commerce, and from the viewpoint of a member store receiving the cryptocurrency as a payment, the possibility of loss due to the volatility of the value of the cryptocurrency each time the cryptocurrency is exchanged with fiat currency or the possibility of loss at the moment of or after making a payment cannot be ruled out. In addition, in the case where the value changes when the user cancels the payment and gets the cryptocurrency back, there may be a serious problem of receiving an amount smaller than the cryptocurrency used for the payment, and above all, since the speed of creating and recording a ledger in the blockchain technique is very low compared to the used computing power, the method of directly using or exchanging cryptocurrency to make an e-commerce payment, in which the payment should be made and recorded in real-time, is inefficient and has a serious problem at the same time.

Therefore, in the case of cryptocurrency having volatility in value, there is still a limit to be replaced with fiat currency in e-commerce or electronic remittance due to the nature of the asset that a user desires to own. In the case of a cryptocurrency such as Stablecoins without having volatility in value, the problem of generating volatility in value at the time point of payment can be solved. However, since it still has the disadvantage (low processing speed due to mutual verification for preventing double spending) of the conventional cryptocurrencies presented above as they are, it is inefficient in electronic payment that requires real-time fast payment processing.

Recently, as a centralized finance (CeFi) method and a decentralized finance) (DeFi) method are mixed even in various financial transactions using cryptocurrency, loan brokerage systems reflecting market prices using cryptocurrency as collateral between individuals or between individuals and institutions (groups) are spotlighted. However, frown the viewpoint of a user, there is a disadvantage in that when the user gets a loan in advance for e-commerce or electronic remittance that may or may not occur in the future, the user should pay the interest although the user does not use the money, and the larger the number of users who desire to get a loan, the transaction fee that should be paid may increase, and in some cases, the risk is high since the transactions or assets are not guaranteed.

On the other hand, a credit payment method using a credit card is widely used the e-commerce of real economy (purchase of products at online/offline member stores).

That is, the credit payment is a method of purchasing with a credit card, which is a token that can make a payment instead of using fiat currency, and making a payment afterwards (hereinafter, referred to as a deferred payment), and specifically, it is a method in which when a user pays for a product with a credit card issued by a credit card company based on the credit as collateral, the credit card company pays the payment amount in advance, after deducting a predetermined fee, to the member store on behalf of the user, and receives the product price from the user after a predetermined period of time. Since a lot of capital is required to establish a credit card company, and it has to bear a high risk of collecting payment amounts (a delay or loss of payment of the user), a lot of efforts and cost should be paid to verify the credit rating of the user, and barriers of entry to the market are very high for late movers.

Particularly, in the early stage of e-commerce, as Value Added Network (VAN) companies supplying communication networks have participated in the middle since there is no proper means for the credit card companies to communicate with offline member stores for credit card payment, and Payment Gateway (PG) companies additionally participate as an electronic payment and settlement agency between the credit card companies and of member stores, e-commerce is constructed in a structure in which the member stores have no choice but to pay high fees as the payment goes through several intermediate payment steps.

Although a deferred payment method of verifying the credit rating of a user using big data or the like and granting as small limit is employed recently, as collecting big data itself is not an easy work, the risk is high and the funds are burdensome for general small and medium businesses to participate.

As another method of making an electronic remittance in real economy, it is general to make a deposit in advance in a bank (including Internet banks) and transfer an amount to a bank account of another user within the range of the deposit. However, there is a problem of transfer fees since the users use different banks, and there is a disadvantage of making a deposit in advance every time.

### SUMMARY OF THE INVENTION

Therefore, the present invention has been made in view of the above problems, and it is an object of the present invention to provide an electronic payment agency method and system using virtual currency with a limit granted based on a cryptocurrency provided as collateral, which allows a user to conveniently purchase products in advance through online or offline e-commerce and pay later, or to use a service of transferring an amount in advance and settling later when the user makes an electronic remittance, although the user does not have fiat currency or a credit card in hand, while retaining the value of virtual assets of cryptocurrency as it is, by freely using virtual currency for electronic payment within the limit granted based on the cryptocurrency provided as collateral, without the need of purchasing or exchanging cryptocurrency in advance each time.

According to an embodiment of the present application, provided is an electronic payment agency method using virtual currency with a limit granted based on a cryptocurrency provided as collateral. The method includes the steps of: receiving a cryptocurrency collateral providing signal from a user terminal or an exchange market server, by a payment agency server, wherein the cryptocurrency collateral providing signal includes any one or more among communication information and security information, cryptocurrency information, cryptocurrency token information, cryptocurrency market price information, cryptocurrency credit rating information, cryptocurrency collateral setting information, and cryptocurrency collateral providing target information; granting a virtual currency limit on the basis of the received cryptocurrency collateral providing signal, by the payment agency server; transmitting a virtual currency information providing signal to the user terminal or the exchange market server, by the payment agency server, wherein the virtual currency information providing signal includes any one or more among communication information and secured cryptocurrency market price information, virtual currency information, virtual currency token information, virtual currency limit information, virtual currency use information, remaining virtual currency information, fiat currency balance information, and accumulated points; receiving a virtual currency payment request signal from the user terminal or the payment request terminal, by the payment agency server, wherein the Virtual currency payment re nest signal includes any one or more among communication information, security information, and payment information; deducting a virtual currency as much as the amount of payment information included in the received virtual currency payment request signal within the virtual currency limit granted to the user, by the payment agency server; and transmitting a virtual currency payment result signal to the user terminal or the payment request terminal, by the payment agency server, wherein the virtual currency payment result signal includes any one or more among communication information, payment information, and payment result information, wherein the payment result information is configured of information on a payment result corresponding to any one among authentication, approval, and rejection, or information on payment guarantee.

According to an embodiment of the present application, provided is an electronic payment agency system using virtual currency with a limit granted based on a cryptocurrency provided as collateral. The system includes a payment agency server. The payment agency server receives a cryptocurrency collateral providing signal from a user terminal or an exchange market server, wherein the cryptocurrency collateral providing signal includes any one or more among communication information and security information, cryptocurrency information, cryptocurrency token information, cryptocurrency market price information, cryptocurrency credit rating information, cryptocurrency collateral setting information, and cryptocurrency collateral providing target information; the payment agency server grants a virtual currency limit on the basis of the received cryptocurrency collateral providing signal. The payment agency server transmits a virtual currency information providing signal to the user terminal or the exchange market server, wherein the virtual currency information providing signal includes any one or more among communication information and secured cryptocurrency market price information, virtual currency information, virtual currency token information, virtual currency limit information, virtual currency use information, remaining virtual currency information, fiat currency balance information, and accumulated points. The payment agency server receives a virtual currency payment request signal from the user terminal or the payment request terminal, wherein the virtual currency payment request signal includes any one or more among communication information, security information, and payment information. The payment agency server processes payment by determining whether or not a virtual currency can be deducted as much as the amount of payment information included in the received virtual currency payment request signal within the virtual currency limit granted to the user. The payment agency server transmits a virtual currency payment result signal to the user terminal or the payment request terminal, wherein the virtual currency payment result signal includes any one or more among communication information, payment information, and payment result information, wherein the payment result information is configured of information on a payment result corresponding to any one among authentication, approval, and rejection, or information on payment guarantee.

According to an embodiment of the present application, provided is an electronic payment agency system using virtual currency with a limit granted based on a cryptocurrency provided as collateral. The system includes an exchange market server for transmitting a cryptocurrency collateral providing signal to a payment agency server or receiving a virtual currency information providing signal from the payment agency server. The cryptocurrency collateral providing signal includes any one or more among communication information and security information, cryptocurrency information, cryptocurrency token information, cryptocurrency market price information, cryptocurrency credit rating information, cryptocurrency collateral setting information and cryptocurrency collateral providing target information. The virtual currency information providing signal includes any one or more among communication information and secured cryptocurrency market price information, virtual currency information, virtual currency token information, virtual currency limit information, virtual currency use information, remaining virtual currency information, fiat currency balance information, and accumulated points. The payment agency server may perform a payment process of granting a virtual currency limit on the basis of the cryptocurrency collateral providing signal, and determining, when a virtual currency payment request signal is received from the user terminal or the payment request terminal, whether or not a virtual currency can be deducted as much as the amount of payment information included in the virtual currency payment request signal within the virtual currency limit granted to the user, and transmit a virtual currency payment result signal to the user terminal or the payment request terminal, wherein the virtual currency payment result signal includes any one or more among communication information, payment information, and payment result information, and the payment result information is configured of information on a payment result corresponding to any one among authentication, approval, and rejection, or information on payment guarantee.

According to an embodiment of the present application, provided is an electronic payment agency system using virtual currency with a limit granted based on a cryptocurrency provided as collateral. The system includes a user terminal for (i) receiving a virtual currency information providing signal from the payment agency server that has granted a virtual currency limit on the basis of a cryptocurrency collateral providing signal, wherein the cryptocurrency collateral providing signal includes any one or more among communication information and security information, cryptocurrency information, cryptocurrency token information, cryptocurrency market price information, cryptocurrency credit rating information, cryptocurrency collateral setting information, and cryptocurrency collateral providing target information, wherein the virtual currency information providing signal includes any one or more among communication information and secured cryptocurrency market price information, virtual currency information, virtual currency token information, virtual currency limit information, virtual currency use information, remaining virtual currency information, fiat currency balance information, and accumulated points, (ii) transmitting a virtual currency payment request signal to the payment agency server so that the payment agency server may perform a payment process of determining whether or not a virtual currency can be deducted as much as the amount of payment information included in the virtual currency payment request signal within the virtual currency limit granted to a user, or (iii) receiving a virtual currency payment result signal from the payment agency server, wherein the virtual currency payment result signal includes any one or more among communication information, payment information, and payment result information, and the payment result information is configured of information on a payment result corresponding to any one among authentication, approval, and rejection, or information on payment guarantee.

According to an embodiment of the present application, provided is an electronic payment agency system using virtual currency with a limit granted based on a cryptocurrency provided as collateral. The system includes a payment request terminal for (i) transmitting a virtual currency payment request signal to a payment agency server that has granted a virtual currency limit on the basis of a cryptocurrency collateral providing signal so that the payment agency server may perform a payment process of determining whether or not a virtual currency can be deducted as much is the amount of payment information included in the virtual currency payment request signal within the virtual currency limit granted to a user, wherein the cryptocurrency collateral providing signal includes any one or more among communication information and security information, cryptocurrency information, cryptocurrency token information, cryptocurrency market price information, cryptocurrency credit rating information, cryptocurrency collateral setting information, and cryptocurrency collateral providing target information, and the virtual currency payment request signal includes any one or more among communication information, security information, and payment information, or (ii) receiving a virtual currency payment result signal from the payment agency server, wherein the virtual currency payment result signal includes any one or more among communication information, payment information, and payment result information, and the payment result information is configured of information on a payment result corresponding to any one among authentication, approval, and rejection, or information on payment guarantee.

### BRIEF DESCRIPTION OF THE DRAWINGS

FIG. 1 is a conceptual view showing an electronic payment agency system using a virtual currency with a limit granted based on a cryptocurrency provided as collateral according to an embodiment of the present invention.

FIG. 2 is as conceptual view showing the step of requesting cryptocurrency collateral from a user terminal used in an electronic payment agency system using a virtual currency with a limit granted based on a cryptocurrency provided as collateral according to an embodiment of the present invention.

FIG. 3 is a conceptual view showing the step of requesting cryptocurrency collateral in an electronic payment agency method using a virtual currency with a limit granted based on a cryptocurrency provided as collateral according to an embodiment of the present invention.

FIG. 4 is a conceptual view showing the step of requesting cryptocurrency payment from a user terminal used in an electronic payment agency system using a virtual currency with a limit granted based on a cryptocurrency provided as collateral according to an embodiment of the present invention.

FIG. 5 is a conceptual view showing the step of requesting cryptocurrency payment in an electronic payment agency method using a virtual currency with a limit granted based on a cryptocurrency provided as collateral according to an embodiment of the present invention.

### REFERENCE NUMERALS

10: Electronic payment agency system
100: User terminals
101: Collateral providing request unit
102: Collateral release request unit
103: Virtual currency payment request unit
104: Virtual currency remittance request unit
105: Fiat currency deposit request unit
106: Fiat currency withdrawal request unit
200: Exchange market server
300: Payment agency server
400: Payment request terminal
500: Network

### DETAILED DESCRIPTION OF INVENTION

For the embodiments of the present invention disclosed in the specification, specific structural and functional descriptions are exemplified only for the purpose of describing the embodiments of the present invention, and the embodiments of the present invention may be applied and modified in various forms and should not be construed as being limited to the embodiments described in the specification.

In addition, descriptions of the functions and configurations of blockchain techniques and other well-known commonly used techniques will be omitted and follow general terms understood by those skilled in the art unless the meaning of the terms is specifically defined.

Hereinafter, preferred embodiments of the present invention will be described in more detail with reference to the accompanying drawings. The same reference numerals are used for the same components in the drawings, and the same components or duplicate descriptions are omitted.

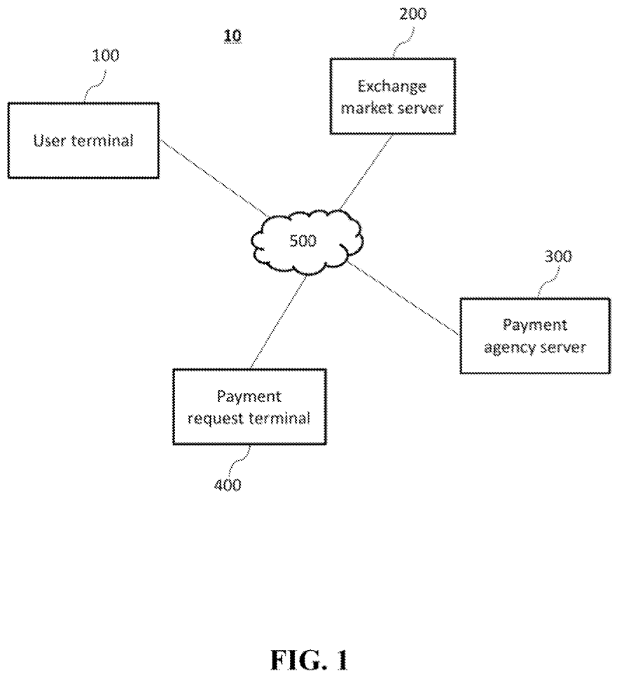

FIG. 1 is a conceptual view showing an electronic payment agency system using a virtual currency with a limit granted based on a cryptocurrency provided as collateral according to an embodiment of the present invention.

Referring to FIG. 1, an electronic payment agency system (10) using a virtual currency with a limit granted based on a cryptocurrency provided as collateral according to the present invention includes any one or more among a user terminal (100), an exchange market server (200), a payment agency server (300) and a payment request terminal (400), and may be connected to a network (500).

The terminals may be an information communication device such as a computer or a smartphone, a dedicated information communication device for using the payment agency system, or a device specialized for payment, or may include one or more programs running on the computer or the smartphone.

The servers may be an information communication device such as a computer or a smartphone, an information communication device such as a dedicated computer or a smartphone for providing a cryptocurrency trading or payment agency system, a device specialized for payment, a dedicated machine for cryptocurrency mining, or a cloud server, or may include one or more programs running on the computer or the smartphone, or one or more programs running on the cloud server.

The user terminal (100) is a terminal used by a user to transmit and receive information or signals. For example, for the present invention, one or more terminals that allow a user to provide cryptocurrency to an exchange market or a payment agency as collateral, receive information on virtual currency with a granted limit from the payment agency server (300), or make an e-commerce payment or electronic remittance may be included in the user terminal (100).

In addition, for the present invention, the user terminal (100) does not necessarily need to be a single or the same terminal, and the present invention can be used through a plurality of terminals.

For example, although a user uses a computer in the case of requesting collateral based on cryptocurrency and uses a smartphone in the case of requesting payment in virtual currency, all of these may be included in the user terminal (100).

Particularly, when the user terminal (100) includes a program running on a computer or a smartphone, the program may be distributed by an exchange market or a payment agency, may be preloaded on a computer or a smartphone, or may be directly installed on a computer or a smartphone by a user.

The exchange market server (200) is a server operated in an exchange market to trade cryptocurrency, and for example, it may include a server that processes tiny one or more among the functions of trading cryptocurrency, setting a market price for the cryptocurrency, setting or releasing collateral on the cryptocurrency, and selling secured cryptocurrency.

In addition, a server for trading cryptocurrency and a server for setting or releasing collateral may be separated and individually operated by each exchange market, and one or more servers that can be integrally operated by one exchange market may be included in the exchange market server (200).

Particularly, the exchange market server (200) includes one or more servers operated by a single exchange market or a plurality of exchange markets, and the exchange market is not necessarily configured of only a single or the same exchange market server (200) for the present invention, and a plurality of exchange market servers (200) may be operated.

The payment agency server (300) is a server operated by a payment agency for a payment agency function, and for example, it may include a server that processes any one or more among the functions of granting a virtual currency limit on the basis of cryptocurrency when the cryptocurrency is provided as collateral, processing a virtual currency payment request received from a user or a member store, or transferring virtual currency or fiat currency or requesting a financial company to make a remittance when a payment process is performed.

At this point, the remittance may be made within the virtual account of the payment agency or through an external financial server included within the scope of the network (500).

In addition, a server that grants a limit of virtual currency, transmits virtual currency information or fiat currency information, processes virtual currency payment, or transfers virtual currency or fiat currency may be separated and individually operated by each payment agency, and one or more servers that can be integrally operated by one payment agency may be included in the payment agency server (300).

Particularly, the payment agency server (300) includes one or more servers operated by a single payment agency or a plurality of payment agencies, and the payment agency is not necessarily configured of only a single or the same payment agency server (300) for present invention, and may be operated by a plurality of payment agency servers (300).

The operators of the exchange market server (200) and the payment agency server (300) may be the same or different, and the servers may be separately or integrally operated by one operator, and in some cases, the exchange market server (200) may be the payment agency server (300), and the payment agency server (300) may also be the exchange market server (200).

The payment request terminal (400) is one or more terminals that can access the payment agency server (300) and use the payment agency service, and for example, one or more terminals or servers that can receive a signal related to a payment result (authentication, approval, rejection, or the like) from the payment agency server (300) when an e-commerce payment or electronic remittance to an online or offline member store or another user is performed using virtual currency through the user terminal (100) may be included in the payment request terminal (400).

It is not that the present invention can be used only when the user terminal (100) and the payment request terminal (400) are separated at all times by hardware or software, and for example, when a user accesses an online member store and purchases a product using a web browser or a product purchase application with one terminal and pays using a payment application, the payment applicant may become the user terminal (100), and the web browser or the product purchase application may become the payment request terminal (400).

When a terminal or a server operated by an offline member store becomes the payment request terminal (400), the terminal through which the user pays in virtual currency may become the user terminal (100).

Particularly, in the present invention, in addition to a user and a member store, a user and another user may implement e-commerce or send and receive an electronic remittance with each other through a direct transaction between the interested parties through a payment agency, and at this point, the terminal used by another user may become the payment request terminal (400). In addition, when the payment request terminal (400) includes a program running on a computer or a smartphone, the program may be distributed by a member store or a payment agency, may be preloaded on a computer or a smartphone, or may be directly installed on a computer or a smartphone by the user, the member store, or the payment agency.

The network (500) is a communication line or circuit provided to allow terminals and servers to transmit and receive information with each other, and may include, for example, a system internal communication path, the Internet, an intranet, a dedicated line, a wired/wireless communication network, and the like, and include one or more intermediate information communication devices that transfer information or perform predetermine information processing on behalf of a user, and in some cases, nodes forming a blockchain may also be included in the network.

In addition, routers, gateways, IDC centers or the like that connect the terminal and the Internet network, firewalls, name servers or the like required for server operation, financial company servers for transmitting fiat currency, and networks constituting the same may all be included in the category of the network (500).

Although the electronic payment agency system (10) using a virtual currency with a limit granted based on a cryptocurrency provided as collateral according to the present invention is software that individually drives the user terminal (100), the exchange market server (200), the payment agency server (300), and the payment request terminal (400) at one terminal, it may be classified into devices according to each function. For example, when a user accesses a website operated by an exchange market using the user terminal (100), an exchange market website access program driven on the user terminal (100) may be the exchange market server (200), and the same principle may be applied to the payment agency server (300) or the payment request terminal (400).

I. According to embodiments, a user may access the exchange market server (200) or the payment agency server (300) through the network (500) using the user terminal (100) for the present invention.

At this point, communications between the user terminal (100) and the exchange market server (200), the payment agency server (300), or the payment request terminal (400), communications between the exchange market server (200) and the payment agency server (300), and communications between the payment agency server (300) and the payment request terminal (400) may transmit and receive signals or information based on communication information.

The communication information may include one or more among user information, exchange market information, payment agency information, member store information, and identification information.

The user information is information that can specify a user, and may be, for example, user terminal (100) information, user Unique identification information, user electronic wallet information, user credit rating information, or the like.

The exchange market information is information that can specify an exchange market, and may be, for example, exchange market server (200) information, exchange market unique identification information, exchange market electronic wallet information, or the like.

The payment agency information is information that can specify a payment agency, and may be, for example, payment agency server (300) information, payment agency unique identification information, payment agency electronic wallet information, or the like.

The member store information is information that can specify a member store or another user, and for example, in the case of a member store, it may be payment request terminal (400) information, member store unique identification information, member store electronic wallet information, or the like, and in the of case another user, the member store information may be replaced with the user information.

In the blockchain, an electronic wallet means a dedicated program used to take over or hand over the ownership of cryptocurrency or to find the ownership of cryptocurrency or transaction records recorded in a block. However, the electronic wallet in the present invention may include all of a program that can confirm the electronic wallet of blockchain, an electronic wallet address recorded in a block, and cryptocurrency information or virtual currency information, a database in the user terminal (100), the exchange market server (200), or the payment agent server (300), a program that displays cryptocurrency or virtual currency information processed in the user terminal (100), the exchange market server (200), or the payment agency server (300) on the user terminal (100), a cryptocurrency trading or collateral application, a virtual currency payment application, and the like.

In addition, a single or a plurally of electronic wallets may be opened in one or more terminals or servers. For example, the electronic wallet may be opened individually or integrally for each type of cryptocurrency or for each purpose of owning the cryptocurrency, and wallets for cryptocurrency management and wallets for virtual currency management may be separately or integrally opened.

The electronic wallet may be opened by one or more among a user, an exchange market, a payment agency, and a member store in any one or more among the user terminal (100), the exchange market server (200), the payment agency server (300), the payment request terminal (400), and the network (500), and may be classified into a user electronic wallet, an exchange market electronic wallet, a payment agency electronic wallet, and a member store electronic wallet according to ownership.

For example, the user electronic wallet may be opened in the user terminal (100), the exchange market server (200), the payment agency server (300), the payment request terminal (400), or the network (500), and the exchange market electronic wallet, the payment agency electronic wallet, and the member store electronic wallet may also be opened in the same manner.

That is, although the user electronic wallet exists in the exchange market server (200), the payment agency server (300), the payment request terminal (400), or the network (500) rather than the user terminal (100), it may become a user electronic wallet, and although the user electronic wallet exists in the exchange market server (200), it may be a payment agency electronic wallet.

In addition, the electronic wallet address may be a public key that is a unique address on the blockchain, and it may be a unique address or account information assigned by any one or more among the user terminal (100), the exchange market server (200), the payment agency server (300) and the payment request terminal (400).

In some cases, account numbers of a user, an exchange market, a payment agency, a member stores, and the like may be used without being distinguished in connection with the electronic wallet address, or the account numbers may be the same.

The identification information is unique information for identifying each signal, information, transaction, record, or the like, and may be generated immediately when any information is generated or received, used to match any two pieces of information with each other, used for the purpose of storing certain information in a database or fetching certain information from the database, or used as a tool or means for transmitting certain information to a terminal or a server, and may be uniquely generated by any one or more among the user terminal (100), the exchange market server (200), the payment agency server (300) and the payment request terminal (400).

In addition, the identification information may be generated as digital information of various forms. For example, the identification information may be generated in various forms, such as a QR code, a barcode, a random number or character string, other digital codes or images, and the like, that can be recognized using an input/output device, and may be generated in plurality or individually, and it may refer to the same identification information in association with a unique character string.

The identification information may be individually generated to be different in each transaction or in each transmuted signal, or only one piece of identification information may be generated and integrally used.

Virtual temporary information associated with various kinds of information that can be included in the communication information may be separately generated and used for communication. For example, actual communication information may be stored in a server or a terminal, and virtual temporary information such as a token may be generated and used in replace of the communication information.

II. According to embodiments, the payment agency server (300) may receive as cryptocurrency collateral providing signal from the user terminal (100) or the exchange market server (200), and transmit a cryptocurrency collateral release signal to the user terminal (100) or the exchange market server (200).

The cryptocurrency collateral providing signal may include any one or more among communication information and security information, cryptocurrency information, cryptocurrency token information, cryptocurrency market price information, cryptocurrency credit rating information, cryptocurrency collateral setting information, and cryptocurrency collateral providing target information.

For example, although a cryptocurrency possessed by a user may be provided as collateral to be granted with a limit of virtual currency, in some cases, smart contract information based on cryptocurrency, issued tokens, tokenized cryptocurrency, or the like may also be provided as collateral.

For example, when a cryptocurrency is provided as collateral, cryptocurrency information may be transmitted from the electronic wallet of the user to the exchange market or payment agency electronic wallet that sets the collateral. However, the right to release or sell the collateral set on the secured cryptocurrency or set on the user's electronic wallet keeping the cryptocurrency may be transferred by transmitting only the cryptocurrency collateral setting information while the cryptocurrency is kept in the user's electronic wallet as is.

The cryptocurrency collateral release signal may include any one or more among communication information and cryptocurrency information, cryptocurrency token information, cryptocurrency collateral release information, and cryptocurrency collateral release target information.

Particularly, in the case where the right to release or sell the collateral set on the secured cryptocurrency or set on the user's electronic wallet keeping the cryptocurrency is transferred by transmitting only the cryptocurrency collateral setting information while the cryptocurrency is kept in the user's electronic wallet as is when the cryptocurrency is provided as collateral, the cryptocurrency collateral setting information and the cryptocurrency collateral release information may be the same.

III. According to embodiments, various methods may be used to provide cryptocurrency in a user's electronic wallet to an exchange market or a payment agency as collateral.

As a first example, of method of transmitting (recording) cryptocurrency from the user's electronic wallet to the exchange market or payment agency electronic wallet (hereinafter, a transfer method between electronic wallets) may be used. In this case, as the cryptocurrency collateral providing signal includes at least information on the cryptocurrency to be provided as collateral, the cryptocurrency may be provided as collateral in a method of transmitting the cryptocurrency to an exchange market or payment agency electronic wallet.

In addition, the exchange market or payment agency electronic wallet may be a separate electronic wallet dedicated for providing cryptocurrency as collateral.

As a second example, a method of transferring the right to release or sell the collateral on the cryptocurrency in the user's electronic wallet to an exchange market or a payment agency without transmitting the cryptocurrency (hereinafter, an electronic wallet right transfer method) may be used. In this case, as the cryptocurrency collateral providing signal includes at least cryptocurrency collateral setting information, not the cryptocurrency to be provided as collateral, it may be regarded that the cryptocurrency is provided as collateral in a method of transferring the right to release or sell the collateral on the cryptocurrency in the user's electronic wallet to an exchange market or a payment agency.

In addition, when the electronic wallet right transfer method is used, the user's electronic wallet may be locked or the cryptocurrency may be frozen so that the cryptocurrency may not be sold or transferred to another electronic wallet while the cryptocurrency is provided as collateral.

As a third example, tokens of cryptocurrency may be issued and provided as collateral, and in this case, it may be regarded that the cryptocurrency is provided as collateral in a method of transmitting the cryptocurrency token information included in the cryptocurrency collateral providing signal to an exchange market or a payment agency.

The token may be issued by any one or more among a user, an exchange market, a payment agency, external governance, an external individual or group, and an external investor.

As a fourth example, for the cryptocurrency provided as collateral, collateral may be provided in a smart contract method between a user and an exchange market or a payment agency, or between an examine market and a payment agency.

The method of providing cryptocurrency provided as collateral may include various methods derived from CeFi or DeFi, and since various methods derived from the real finance may be adopted and applied and various methods may be devised in the future in addition, it should not be construed as being limited to the method presented as embodiments in the present invention.

IV. According to embodiments, the payment agency server (300) may grant a virtual currency within a predetermined limit on the basis of the received cryptocurrency collateral providing signal.

For example, when cryptocurrency market price information (e.g., one million Korean Won) is included in the cryptocurrency collateral providing signal received by the payment agency server (300), the payment agency may grant one million Korean Won as a virtual currency limit in proportion to the cryptocurrency market price information (although a currency unit the same as that of fiat currency is used for better understanding, it may be changed without restriction), and when the cryptocurrency collateral providing signal does not include the cryptocurrency market price information and includes only the information on the cryptocurrency provided as collateral or the cryptocurrency token information, the payment agency may separately acquire cryptocurrency market price information from the exchange market or set a market price by itself, and grant a virtual currency limit on the basis of the market price.

Particularly, even after a virtual currency limit is granted, the payment agency server (300) may acquire market price information of the secured cryptocurrency from the exchange market server (200) in real-time or at regular intervals, and re-grant the virtual currency limit.

Although an example of granting a virtual currency limit in proportion to the market price of a secured cryptocurrency is presented in an embodiment of the present invention, the granted virtual currency limit may be increased or decreased or changed without restriction according to the circumstances (credit rating of the user or credit rating of cryptocurrency, real-time market price, or the like), and although a cryptocurrency is not necessarily provided as collateral, the virtual currency limit may be granted at the discretion of the payment agency even based on the user's credit rating information among the information on the user possessing the cryptocurrency or based on the payment guarantee of the exchange market or an external payment guarantee included in the user's credit rating information to pay on behalf of the user.

In addition, according to the business agreement between an exchange market and a payment agency, a virtual currency with a limit that can be granted in association with the market price of the cryptocurrency handled by the exchange market may be set in advance, and the user may request to set a cryptocurrency as collateral only as much as needed with reference to the limit of the virtual currency, and be granted with a virtual currency limit.

The virtual currency may be issued or transactions may be recorded on the basis of blockchain, and it may be a digital currency issued or managed by an exchange market or a payment agency.

V. According to embodiments, the payment agency server (300) may transmit a virtual currency information providing signal to the user terminal (100) or the exchange market server (200).

The virtual currency information providing signal may include any one or more among communication information and secured cryptocurrency market price information, virtual currency information, virtual currency token information, virtual currency limit information, virtual currency use information, remaining virtual currency information, fiat currency balance information, and accumulated points.

VI. According to embodiments, the payment agency server (300) may receive a virtual currency payment request signal from the user terminal (100) or the payment request terminal (400), and transmit a virtual currency payment result signal to the user terminal (100) or the payment request terminal (400).

The virtual currency payment request signal may include any one or more among communication information security information, and payment information.

The payment information may be payment amount information for e-commerce payment or electronic remittance.

At this point, it is preferable that the payment amount should be used for payment within a virtual currency to which a limit is granted or within a balance.

The virtual currency payment result signal may include any one or more among communication information, payment information, and payment result information.

The payment result information is information on a payment result, such as any one among authentication, approval, and rejection processed by the payment agency server (300) for payment, or information on payment guarantee, and for example, it may be information including a unique character string such as a hash data or a digital signature value, transaction record information or a message or specific code of a transaction result, or token information generated or issued according to a payment result.

The payment processing of the payment agency server (300) is deducting at virtual currency or determining deduction as much as the amount of payment information within the virtual currency limit granted to the user, and for example, when deduction as much as the payment information can be made within the balance of the virtual currency granted with a limit, authentication or approval is determined after the amount is deducted, and when deduction cannot be made, it is determined as rejection.

When the virtual currency payment processing is normally performed, the payment agency may remit virtual currency or fiat currency to a member store or another user or request a financial company to remit fiat currency according to a predetermined agreement.

When virtual currency is exchanged for fiat currency, an exchange market is used, or a payment agency may directly exchange and transfer the fiat currency.

When a user or a member store desires to cancel a virtual currency payment, the virtual currency payment request signal is replaced with a virtual currency payment cancellation request signal, so that the payment information may become payment information for cancellation, and a procedure for obtaining consent from a cancellation target may be added.

VII. According to embodiments, the payment agency server (300) may receive a fiat currency deposit signal or a fiat currency withdrawal signal from the user terminal (100).

The fiat currency deposit signal may include any one or more among communication information, security information, fiat currency deposit information, and deposit account information.

The fiat currency withdrawal signal may include any one or more among communication information, security information, fiat currency withdrawal information, and withdrawal account information.

For example, a user granted with a limit of one million Korean Won in virtual currency may purchase a product from a member store or make a remittance to another user within the limit, and when the user has used virtual currency of 100,000 Korean Won for payment, the payment agency may deduct 100,000 Korean Won from the virtual currency limit of one million Korean Won granted to the user and request to make a payment or remittance in virtual currency or fiat currency equal to the value of 100,000 Korean Won from the member store or another user on behalf of the user, and the user ay deposit 100,000 Korean Won in fiat currency corresponding to the used virtual currency to the payment agency within a stipulated time.

At this point, since the cryptocurrency is set as collateral, it is preferable not to use the cryptocurrency for payment at all.

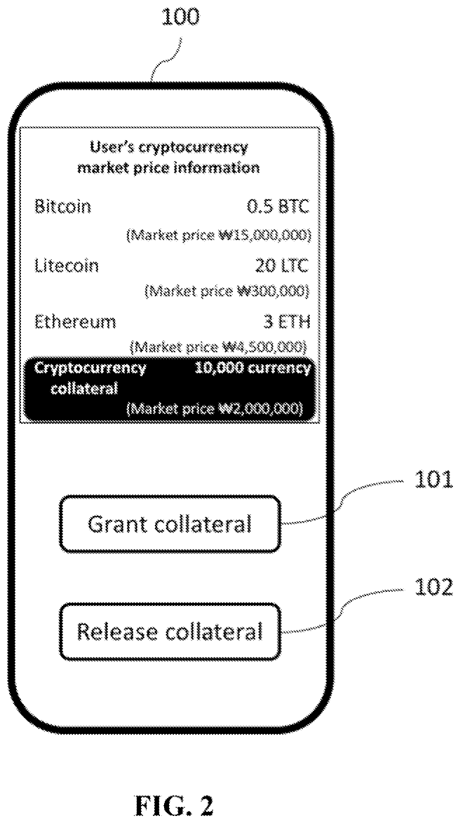

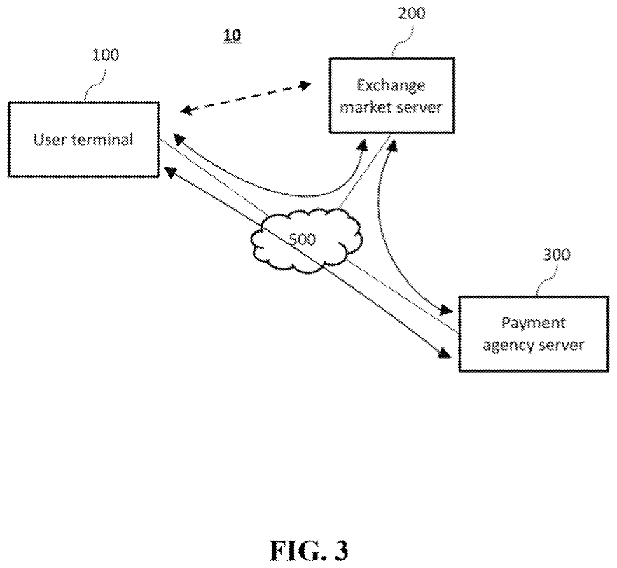

The procedures of the payment agency server (300) for receiving a cryptocurrency collateral providing signal from the user terminal (100) or the exchange market server (200) and transmitting a cryptocurrency collateral release signal to the user terminal (100) or the exchange market server (200) may be shown belt w as an example with reference to FIGS. 2 and 3.

FIG. 2 is a conceptual view showing the step of requesting cryptocurrency collateral from a user terminal (100) used in an electronic payment agency system (10) using a virtual currency with a limit granted based on a cryptocurrency provided as collateral according to an embodiment of the present invention.

Referring to FIG. 2, market price information of the cryptocurrency possessed by the user received from the exchange market may be displayed on the user terminal (100), and the user may request the exchange market or the payment agency to set a cryptocurrency, desired to be provided as collateral, as collateral through a collateral providing request unit (101), and the user may request the exchange market or the payment agency to release collateral of a cryptocurrency, desired to be released from collateral, through a collateral release request unit (102).

FIG. 3 is a conceptual view showing the step of requesting cryptocurrency collateral in an electronic payment agency method using a virtual currency With a limit granted based on a cryptocurrency provided as collateral according to an embodiment of the present invention.

Referring to FIG. 3, when the user terminal (100) requests the exchange market server (200) or the payment agency server (300) to set a cryptocurrency as collateral, the payment agency server (300) may receive a cryptocurrency collateral providing signal from the user terminal (100) or the exchange market server (200). When the user terminal (100) requests the exchange market server (200) or the payment agency server (300) to release the collateral on the cryptocurrency or a cryptocurrency collateral release request is arbitrarily issued by the payment agency server (300), the payment agency server (300) may transmit a cryptocurrency collateral release signal to the user terminal (100) or the exchange market server (200).

In normal cases, the payment agency server (300) may transmit a cryptocurrency collateral release signal to a subject that has transmitted the cryptocurrency collateral providing signal among the user terminal (100) and the exchange market server (200). In some cases, the cryptocurrency collateral release signal may be transmitted to a subject other than the subject that has transmitted the cryptocurrency collateral providing signal, and the cryptocurrency collateral release signal may be transferred to a subject who has transmitted the cryptocurrency collateral providing signal through another subject that has received the cryptocurrency collateral release signal.

For example, a cryptocurrency collateral providing signal may be transmitted from the user terminal (100) to the payment agency server (300) in response to a user's request, and a cryptocurrency collateral release signal may be transmitted from the payment agency server (300) to the user terminal (100) in response to a user's request. In some cases, the cryptocurrency collateral release signal may be transmitted from the payment agency server (300) to the exchange market server (200) to compulsorily liquidate the cryptocurrency of the user or withdraw the virtual currency limit in response to the request of the payment agency or may be transmitted by system implementation, and the cryptocurrency collateral release signal may also be transferred to the user terminal (100) through the exchange market server (200).

As another example, the cryptocurrency collateral providing signal may be transmitted from the exchange market server (200) to the payment agency server (300) in response to a user's request, and the cryptocurrency collateral release signal may be transmitted from the payment agency server (300) to the exchange market server (200) in response to a user's request. In some cases, the cryptocurrency collateral release signal may be transmitted from the payment agency server (300) to the user terminal (100) in response to a user's request or by system implementation, and the cryptocurrency collateral release signal may also be transferred to the exchange market server (200) through the user terminal (100).

When a virtual currency limit is granted based on the cryptocurrency collateral providing signal received by the payment agency server (300), a virtual currency information providing signal may be transmitted from the payment agency server (300) to the user terminal (100) or the exchange market server (200).

The virtual currency information providing signal may be repeatedly transmitted while the user's cryptocurrency is provided as collateral or whenever a virtual currency payment is made.

When the cryptocurrency collateral providing signal is transmitted from the user terminal (100) to the payment agency server (300), the payment agency server (300) may directly transmit a virtual currency information providing signal to the user terminal (100) on the basis of the user information of the communication information included in the cryptocurrency collateral providing signal.

When the user terminal (100) requests the exchange market server (200) to set a cryptocurrency as collateral and the cryptocurrency collateral providing signal is transmitted from the exchange market server (200) to the payment agency server (300), the payment agency server (300) may directly transmit a virtual currency information providing signal to the user terminal (100) on the basis of the user information of the communication information included in the cryptocurrency collateral providing signal, and the virtual currency information providing signal may be transferred to the user terminal (100) via the exchange market server (200) by transmitting the virtual currency information providing signal to the exchange market server (200).

At this point, the virtual currency information providing signal is transferred from the payment agency server (300) to the user terminal (100) via the exchange market server (200) as the exchange market server (200) transmits the virtual currency information providing signal received from the payment agency server (300) to the user terminal (100) on the basis of the communication information.

When the payment agency server (300) does not know the user information for transmitting the virtual currency information providing signal or the virtual currency information providing signal should not be transmitted to the exchange market server (200), the payment agency server (300) may transmit the virtual currency information providing signal to the user terminal (100) using the identification information included in the communication information transmitted to the exchange market server (200).

For example, only when the identification information associated with the virtual currency information providing signal is generated by tine payment agency server (300) and transferred to the user terminal (100) through the exchange market server (200), and the user information including the identification information is transmitted from the user terminal (100) to the payment agency server (300), the payment agency server (300) may transmit a virtual currency information providing signal associated with the identification information to the user terminal (100). At this point, the identification information may be identification information already included in the communication information or identification information newly included in the communication information.

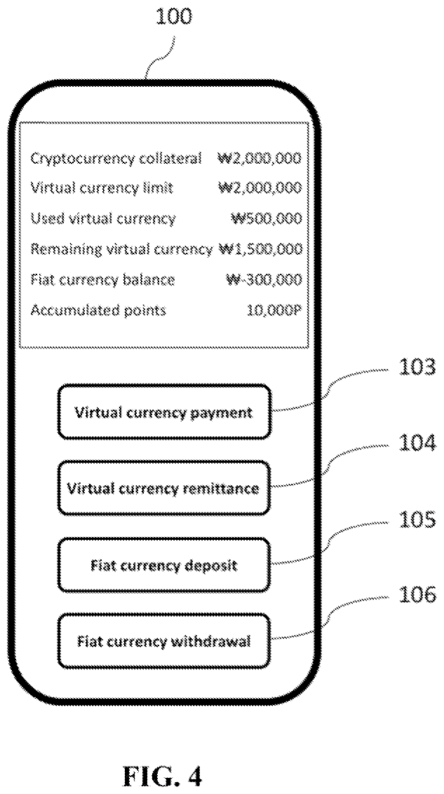

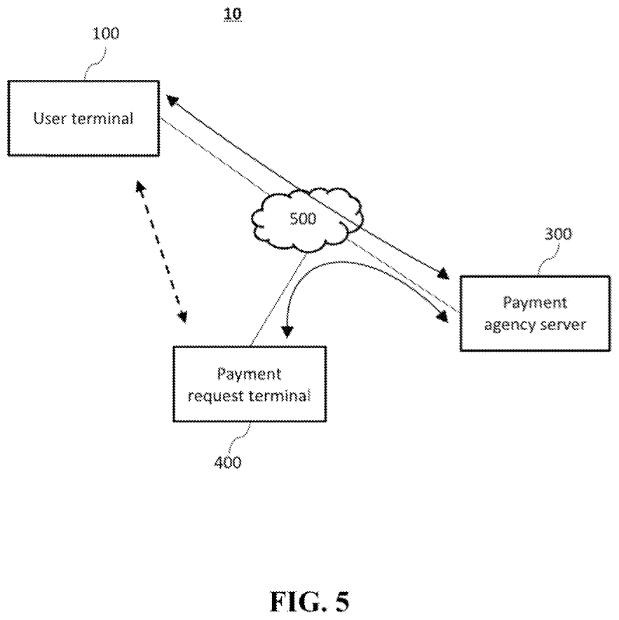

The procedures of receiving a virtual currency payment request signal from the user terminal (100) or the payment request terminal (400), and transmitting a virtual currency payment result signal to the user terminal (100) or the payment request terminal (400) by the payment agency server (300) may be shown below as an example with reference to FIGS. 4 and 5.

FIG. 4 is a conceptual view showing the step of requesting cryptocurrency payment from a user terminal (100) used in an electronic payment agency system (10) using a virtual currency with a limit granted based on a cryptocurrency provided as collateral according to an embodiment of the present invention.

Referring to FIG. 4, the user terminal (100) may display virtual currency information granted with a limit by a payment agency. The user may request the payment agency to make a payment in virtual currency through the virtual currency payment request unit (103) to purchase an e-commerce product in virtual currency. The user may request the payment agency to make an electronic remittance through a virtual currency remittance request unit (104) to make a virtual currency remittance. To pay for the used virtual currency in fiat currency, the payment agency may be requested to deposit fiat currency through a fiat currency deposit request unit (105). To withdraw the received fiat currency, the payment agency may be requested to withdraw fiat currency through a fiat currency withdrawal request unit (106).

For example, the fiat currency balance displayed as −300,000 Korean Won in the virtual currency information of FIG. 4 means that when the amount of virtual currency used by the user to make a payment is 500,000 Korean Won, the fiat currency balance for deferred payment of the user to the payment agency should be −500,000 Korean Won. However, when an electronic remittance of 200,000 Korean Won is received from another user in virtual currency, the fiat currency balance becomes −300,000 Korean Won as the amount of 200,000 Korean Won prepaid (paid) by the payment agency in fiat currency on behalf of another user is added, and when the user makes a deferred payment to the payment agency only as much as this amount, it may be considered that the payment is completed. This is only an example for better understanding of the present invention, and virtual currency information may be applied in various forms.

FIG. 5 is a conceptual view showing the step of requesting cryptocurrency payment in an electronic payment agency method using a virtual currency with a limit granted based on a cryptocurrency provided as collateral according to an embodiment of the present invention.

Referring to FIG. 5, a virtual currency payment request signal may be transmitted from the user terminal (100) or the payment request terminal (400) to the payment agency server (300). A virtual currency payment result signal may be transmitted from the payment agency server (300) to the user terminal (100) or the payment request terminal (400). A fiat currency deposit signal or a fiat currency withdrawal signal may be transmitted from the user terminal (100) to the payment agency server (300).

When the exchange market server (200) makes an e-commerce payment or an electronic remittance, the exchange market server (200) may be a payment agency server (300).

According to embodiments, a user may make an e-commerce payment or an electronic remittance to a member store or another user using a virtual currency granted with a limit from a payment agency, and the payment agency may process the payment in various ways.

As a first example, when a virtual currency payment request signal including at least communication information and security information or payment information is received from the user terminal (100) or the payment request terminal (400), the payment agency server (100) may transmit a virtual currency payment result signal to the user terminal (100) or the payment request terminal (400) after processing the payment. At this point, the communication information may include an one or more among member store information and user information.

As a second example, when as virtual currency payment request signal including at least communication information and payment information is received from the payment request terminal (400), the payment agency server (300) may transmit payment information to the user terminal (100) on the basis of the communication information. When a virtual currency payment request signal including at least communication information and security information is received from the user terminal (100), the payment agency server (300) may transmit a virtual currency payment result signal to the user terminal (100) or the payment request terminal (400) after processing the payment. At this point, the communication information may include any one or more among user information and identification information.

As a third example, when a virtual currency payment request signal including at least communication information and payment information is received from the payment request terminal (400), the payment agency server (300) may assign identification information associated with payment information. When the identification information is transferred to the user terminal (100) through the payment request terminal (400), and the communication information including at least the identification information is transmitted from the user terminal (100) to the payment agency server (300), the payment agency server (300) may transmit payment information associated with the identification information to the user terminal (100) on the basis of the communication information. When a virtual currency payment request signal including at least communication information and security information is received from the user terminal (100), the payment agency sorer (300) may transmit a virtual currency payment result signal to the user terminal (100) or the payment request terminal (400) after processing the payment. At this point, the communication information may include any one or more among user information, payment agency information, and identification information.

As a fourth example, when as virtual currency payment request signal including at least communication information and security information is received from the user terminal (100), the payment agency server (300) may assign identification information associated with the virtual currency payment request signal, and when the identification information is transferred to the payment request terminal (400) through the user terminal (100), and a virtual currency payment request signal including at least the communication information including the identification information and the payment information is transmitted from the payment request terminal (400) to the payment agency server (300), the payment agency server (300) may transmit a virtual currency payment result signal to the user terminal (100) or the payment request terminal (400) after processing the payment. At this point, the communication information may include any one or more among user information, member store information, payment agency information, and identification information.

As a fifth example, when a virtual currency payment request signal including at least communication information and security information is received from the user terminal (100), and a virtual currency payment request signal including at least communication information and payment information is received from the payment request terminal (400), the payment agency server (300) may transmit a virtual currency payment result signal to the user terminal (100) or the payment request terminal (400) after processing the payment by matching the virtual currency payment request signals in which specific information included in the communication information matches each other. At this point, the specific information included in the communication information may include any one or more among user information, member store information, payment agency information, and identification information.

The payment processing method of the payment agency should not be limited to the embodiments, and various methods may be applied by combining information included in the virtual currency payment request signal and information included in the virtual currency payment result signal.

Particularly, transmission in the present invention includes both direct transmission and indirect transmission, and transfer is communication of a higher concept including the transmission, and for example, a process of inputting, by an input device of a terminal or a server, the information displayed by an output device of a terminal or a server may be included in the transfer, and referring to FIGS. 3 and 5, the arrows indicated by a solid line between components may be a process of transmitting signals or information, and the arrows indicated by a dotted line between components may be a process of transferring signals or information, and transmission of a signal or information through a certain component may also be included in the transfer.

According to embodiments, when a fiat currency deposit signal is received from the user terminal (100), the payment agency server (300) may withdraw fiat currency on the basis of the account information of the user information, and when a fiat currency withdrawal signal is received, the payment agency server (300) may transfer fiat currency on the basis of the account information of the user information.

The account information may be account information of the user's unique identification information included in the user information of the communication information, may be a bank account or a virtual account provided by a payment agency, or may be an electronic wallet.

Particularly, when a deferred payment deadline arrives, the payment agency may automatically withdraw money on the basis of the user's account information, and when a collateral release request for cryptocurrency is received from the user, the payment agency in transmit a cryptocurrency collateral release signal after confirming whether the amount of using the virtual currency is fully paid in fiat currency. When the user does not pay even when the fiat currency payment deadline arrives, compulsory liquidation of the secured cryptocurrency may be made, and when the market price of the secured cryptocurrency plunges, the cryptocurrency may be compulsorily liquidated, or the limit of the virtual currency may be reduced or withdrawn.

According to the electronic payment agency method and system of the present invention using virtual currency with a limit granted based on a cryptocurrency provided as collateral, first, from the viewpoint of a user, it is possible to conveniently purchase products through online or offline e-commerce or make an electronic remittance to another user although the user does not have fiat currency or a credit card in hand using virtual currency with a limit granted based on the cryptocurrency provided as collateral while retaining the cryptocurrency as it is as a virtual asset having volatility in value.

Second, from the viewpoint of a payment agency, the risk of collecting payment amounts can be reduced greatly as the user's cryptocurrency can be secured as collateral, and since information comparable to big data can be collected when the credit rating of the user possessing the cryptocurrency is consistently managed, the cost for credit check can be reduced significantly. In addition, since the number of transaction records can be reduced through a virtual currency payment process in a payment agency server, and double spending of a user does not need to be verified, computing power can be reduced while increasing the payment processing speed, and thus unnecessary energy waste can be reduced, and operating cost also can be reduced.

Third, from the viewpoint of a member store, it is possible to reduce the dependence on the conventional credit card or account transfer payment method, which has no choice but to pay high fees by going through several steps in the e-commerce payment process, and fees can be significantly reduced by adopting a direct payment method with a payment agency.

As described above, although the present invention has been described through the limited embodiments and drawings, the present invention is not limited to the embodiments, and those skilled in the art may make various changes and modifications from these descriptions. Accordingly, the spirit of the present invention should be grasped only by the claims described below, and all equivalents or equivalent modifications thereof will fall within the scope of the spirit of the present invention.

Particularly, in the present invention, information included in the signals transmitted and received between the components means that other information not described may be included as needed in addition to any one or more of them, and it should not be construed that only the information described in the present invention is included in the signals.

In addition, the terminals or servers according to the present invention are devices and may be implemented as a computer-readable code on a computer-readable recording medium. The computer-readable recording medium includes all types of recording devices in which data that can be read by a computer system are stored.

What is claimed is:

1. An electronic payment agency method using virtual currency with a limit granted based on a cryptocurrency provided as collateral, the method comprising the steps of:
receiving a cryptocurrency collateral providing signal from a user terminal or an exchange market server, by a payment agency server, wherein the cryptocurrency collateral providing signal includes any one or more among communication information and security information, cryptocurrency information, cryptocurrency token information, cryptocurrency market price information, cryptocurrency credit rating information, cryptocurrency collateral setting information, and cryptocurrency collateral providing target information;
granting a virtual currency limit on the basis of the received cryptocurrency collateral providing signal, by the payment agency server;
transmitting a virtual currency information providing signal to the user terminal or the exchange market server, by the payment agency server, wherein the virtual currency information providing signal includes any one or more among communication information and secured cryptocurrency market price information, virtual currency information, virtual currency token information, virtual currency limit information, virtual currency use information, remaining virtual currency information, fiat currency balance information, and accumulated points;
receiving a virtual currency payment request signal from the user terminal or the payment request terminal, by the payment agency server, wherein the virtual currency payment request signal includes any one or more among communication information, security information, and payment information;
deducting a virtual currency as much as the amount of payment information included in the received virtual currency payment request signal within the virtual currency limit granted to the user, by the payment agency server; and
transmitting a virtual currency payment result signal to the user terminal or the payment request terminal, by the payment agency server, wherein the virtual currency payment result signal includes any one or more among communication information, payment information, and payment result information, wherein the payment result information is configured of information on a payment result corresponding to any one among authentication, approval, and rejection, or information on payment guarantee.

2. An electronic payment agency system using virtual currency with a limit granted based on a cryptocurrency provided as collateral, the system comprising a payment agency server, wherein
the payment agency server receives a cryptocurrency collateral providing signal from a user terminal or an exchange market server, wherein the cryptocurrency collateral providing signal includes any one or more among communication information and security information, cryptocurrency information, cryptocurrency token information, cryptocurrency market price information, cryptocurrency credit rating information, cryptocurrency collateral setting information, and cryptocurrency collateral providing target information;
the payment agency server grants a virtual currency limit on the basis of the received cryptocurrency collateral providing signal;
the payment agency server transmits a virtual currency information providing signal to the user terminal or the exchange market server, wherein the virtual currency information providing signal includes any one or more among communication information and secured cryptocurrency market price information, virtual currency information, virtual currency token information, virtual currency limit information, virtual currency use information, remaining virtual currency information, fiat currency balance information, and accumulated points;
the payment agency server receives a virtual currency payment request signal from the user terminal or the payment request terminal, wherein the virtual currency payment request signal includes any one or more among communication information, security information, and payment information;
the payment agency server processes payment by determining whether or not a virtual currency can be deducted as much as the amount of payment information included in the received virtual currency payment request signal within the virtual currency limit granted to the user; and
the payment agency server transmits a virtual currency payment result signal to the user terminal or the payment request terminal, wherein the virtual currency payment result signal includes any one or more among communication information, payment information, and payment result information, wherein the payment result information is configured of information on a payment result corresponding to any one among authentication, approval, and rejection, or information on payment guarantee.

3. An electronic payment agency system using virtual currency with a limit granted based on a cryptocurrency provided as collateral, the system comprising
an exchange market server for
transmitting a cryptocurrency collateral providing signal to a payment agency server or receiving a virtual currency information providing signal from the payment agency server, wherein
the cryptocurrency collateral providing signal includes any one or more among communication information and security information, cryptocurrency information, cryptocurrency token information, cryptocurrency market price information, cryptocurrency credit rating information, cryptocurrency collateral setting information, and cryptocurrency collateral providing target information, and
the virtual currency information providing signal includes any one or more among communication information and secured cryptocurrency market price information, virtual currency information, virtual currency token information, virtual currency limit information, virtual currency use information, remaining virtual currency information, fiat currency balance information, and accumulated points; and
allowing the payment agency server to perform a payment process of granting a virtual currency limit on the basis of the cryptocurrency collateral providing signal, and determining, when a virtual currency payment request signal is received from the user terminal or the payment request terminal, whether or not a virtual currency can be deducted as much as the amount of payment information included in the virtual currency payment request signal within the virtual currency limit granted to the user, and transmit a virtual currency payment result signal to the user terminal or the payment request terminal,
wherein the virtual currency payment result signal includes any one or more among communication information, payment information, and payment result information, and the payment result information is configured of information on a payment result corresponding to any one among authentication, approval, and rejection or information on payment guarantee.

4. An electronic payment agency system using virtual currency with a limit granted based on a cryptocurrency provided as collateral, the system comprising
a user terminal for
receiving a virtual currency information providing signal from the payment agency server that has granted a virtual currency limit on the basis of a cryptocurrency collateral providing signal, wherein
the cryptocurrency collateral providing signal includes any one or more among communication information and security information, cryptocurrency information, cryptocurrency token information, cryptocurrency market price information, cryptocurrency credit rating information, cryptocurrency collateral setting information, and cryptocurrency collateral providing target information, and
the virtual currency information providing signal includes any one or more among communication information and secured cryptocurrency market price information, virtual currency information, virtual currency token information, virtual currency limit information, virtual currency use information, remaining virtual currency information, fiat currency balance information, and accumulated points,
transmitting a virtual currency payment request signal to the payment agency server to allow the payment agency server to perform a payment process of determining whether or not a virtual currency can be deducted as much as the amount of payment information included in the virtual currency payment request signal within the virtual currency limit granted to a user, or
receiving a virtual currency payment result signal from the payment agency server,
wherein the virtual currency payment result signal includes any one or more among communication information, payment information, and payment result information, and the payment result information is configured of information on a payment result corresponding to any one among authentication, approval, and rejection, or information on payment guarantee.

5. An electronic payment agency system using virtual currency with a limit granted based on a cryptocurrency provided as collateral, the system comprising
a payment request terminal for
transmitting a virtual currency payment request signal to a payment agency server that has granted a virtual currency limit on the basis of a cryptocurrency collateral providing signal to allow the payment agency server to perform a payment process of determining whether or not a virtual currency can be deducted as much as the amount of payment information included in the virtual currency payment request signal within the virtual currency limit granted to a user, wherein the cryptocurrency collateral providing signal includes any one or more among communication information and security information, cryptocurrency information, cryptocurrency token information, cryptocurrency market price information, cryptocurrency credit rating information, cryptocurrency collateral setting information, and cryptocurrency collateral providing target information, and the virtual currency payment request signal includes any one or more among communication information, security information, and payment information, or
receiving a virtual currency payment result signal from the payment agency server, wherein the virtual currency payment result signal includes any one or more among communication information, payment information, and payment result information, and the payment result information is configured of information on a payment result corresponding to any one among authentication, approval, and rejection, or information on payment guarantee.
